(19) United States
(12) Patent Application Publication
(10) Pub. No.: US 2026/0278520 A1
(43) Pub. Date: Sep. 17, 2026

(54) REAL-TIME MODIFICATION TO A SHIPMENT PLAN

(71) Applicant: Certu Systems, Inc., Pittsburgh, PA (US)

(72) Inventor: Hyong Sok Kim, Pittsburgh, PA (US)

(21) Appl. No.: 19/076,532

(22) Filed: Mar. 11, 2025

(51) Int. Cl. G06Q 10/0833; G06Q 10/083

(52) U.S. Cl. CPC G06Q 10/0833; G06Q 10/0838

(57) ABSTRACT

One embodiment provides a method, the method including: generating, utilizing a shipment ordering system, a shipment plan, wherein the shipment plan comprises at least one transportation order for at least one object; receiving, at the shipment ordering system, user input comprising a modification for modifying at least one variable of the shipment plan; validating, using the shipment ordering system, the modification to the shipment plan against information of the shipment ordering system; and tracking, utilizing the shipment ordering system, transportation of the at least one object in view of the shipment plan. Other aspects are claimed and described.

### BACKGROUND

Logistics is the process of managing how objects are obtained, stored, and transported to a final destination of the object. The transportation of objects includes transportation from a manufacturing facility to a destination where objects might be utilized by different companies or entities. The transportation also includes storing objects within warehouses until a final location is identified. The warehouses provide a buffer for the storage of objects that can fulfill a demand while new quantities of the object are manufactured. Thus, an entity may be able to order an object and receive it within a short period of time as opposed to having to wait until the object is manufactured. To get objects from one location to another, for example, from a manufacturing location to a warehouse, from a warehouse to another warehouse, from a warehouse to a final location, and/or the like, different transportation modes may be utilized. Different transportation modes may include boats, airplanes, trucks, and/or the like. These transportation modes allow for the transportation of many different goods at the same time, which is particularly useful for the movement of large amounts of objects from one location to another.

### BRIEF SUMMARY

In summary, one aspect provides a method, the method including: generating, utilizing a shipment ordering system, a shipment plan, wherein the shipment plan comprises at least one transportation order for at least one object; receiving, at the shipment ordering system, user input comprising a modification for modifying at least one variable of the shipment plan; validating, using the shipment ordering system, the modification to the shipment plan against information of the shipment ordering system; and tracking, utilizing the shipment ordering system, transportation of the at least one object in view of the shipment plan.

Another aspect provides a system, the system including: a processor; a memory device that stores instructions that, when executed by the processor, causes the system to: generate, utilizing a shipment ordering system, a shipment plan, wherein the shipment plan comprises at least one transportation order for at least one object; receive, at the shipment ordering system, user input comprising a modification for modifying at least one variable of the shipment plan; validate, using the shipment ordering system, the modification to the shipment plan against information of the shipment ordering system; and track, utilizing the shipment ordering system, transportation of the at least one object in view of the shipment plan.

A further aspect provides a product, the product including: a computer-readable storage device that stores executable code that, when executed by a processor, causes the product to: generate, utilizing a shipment ordering system, a shipment plan, wherein the shipment plan comprises at least one transportation order for at least one object; receive, at the shipment ordering system, user input comprising a modification for modifying at least one variable of the shipment plan; validate, using the shipment ordering system, the modification to the shipment plan against information of the shipment ordering system; and track, utilizing the shipment ordering system, transportation of the at least one object in view of the shipment plan.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example device.

FIG. 2 illustrates an example method for receiving and validating modifications to a shipment plan for an object and tracking the object during the transportation.

### DETAILED DESCRIPTION

In a product lifecycle, the product or object is generally moved from one location to another. Some of these locations include the manufacturing facility and warehouses or product storage locations that store the products or objects until they are needed or desired. When the product or object needs to be moved, a transportation order is created to move the object from the current location to the target location. Frequently, a logistics company will take care of creating a shipment plan. The logistics company will receive the transportation order which identifies what object is to be moved, an amount of the object to be moved, and a destination of the object. The transportation order may include additional information including, but not limited to, a preferred origin location, a preferred transporter, and/or the like.

Some or all of this information may be utilized by the logistic company, or other entity that is creating the shipment plan, to create the shipment plan. The shipment plan details all the relevant information that will be needed to move the object from an origin location to a destination location. The relevant information may include everything from the type of transportation vehicle to the route that should be taken to transport the object. The relevant information may also identify how long the transportation will take, any inventory constraints, any transportation constraints, and/or the like.

Once the shipment plan is generated, it is transmitted to the company that will actually effectuate the transportation of the object. This company or entity may be the one that dispatches transportation vehicles, the company or entity that is holding the objects for transport, and/or the like. Once the transporting company receives the shipment plan, the transporting company may want to make changes to the shipment plan. For example, the transporting company may know of changes to the route that would affect the transportation of the object per the shipment plan, the transporting company may want to use a different transporter or transportation vehicle, the transporting company may not have access to a particular transporter, and/or any other variety of reasons for making modifications to the shipment plan.

Currently, when a change is made to the shipment plan, this change is simply made and then the shipment plan is effectuated. In other words, the transporting company marks up the shipment plan, and then causes the marked-up shipment plan to be carried out. However, a transporting company may make changes to the shipment plan that are contrary to inventory or transportation constraints. Changes may also be outside a normal shipment or transportation plan. For example, the transporting company may want to add objects to the transportation vehicle that are outside the logistics cycle. However, currently there is no way to validate the modifications or changes that a company may make to a shipment plan. In other words, the process of making changes to a shipment plan does not allow for a confirmation of whether the changes are actually possible, particularly in view of inventory or transportation constraints.

Accordingly, the described system and method provides a technique for receiving and validating modifications to a shipment plan for an object and tracking the object during the transportation. A shipment ordering system generates a shipment plan based upon a transportation order for transporting at least one object from an origin location to a destination location. A transportation order is specific to an object, and/or product, that requires transporting from an origin location to final location. A transportation order may be for a particular leg of the transportation of the object from the origin location to the destination location. For example, if an object is to be transported from location A to final location B and has an intermediate stop at location C, then the shipment plan would contain at least two transportation orders for the transportation of the object. Separate transportation orders may also, or alternatively, be created for changes in transporters, changes in transportation vehicles, stops for the transportation vehicle even if the objects are not offloaded, certain lengths of time, and/or any other changes in the transportation of the objects.

Therefore, a shipment plan may include all the transportation orders generated for the transportation of the object from the origin location to the destination location. Each transportation order may include variables or characteristics associated with each object to be transported, for example, origin and final location, travel information (e.g., distance, estimated time arrival), type of transportation (e.g., vehicle type), packaging information (e.g., size of a product, size of a package containing a product, packaging limitations), loading/unloading times, and/or the like. The shipment plan is validated by the shipment ordering system to ensure that the details of the shipment plan conform with inventory and transportation constraints.

After generation of the shipment plan, the shipment plan may be transmitted to a transportation entity or company. The transportation entity or company may decide that a modification is to be made to the shipment plan. A user or entity or company may provide user input to the shipment ordering system that includes the desired modification. Upon receiving the modification to the shipment plan, the shipment ordering system validates the modification. The validation may include validating the modification against information of the shipment ordering system, for example, transportation constraints, inventory constraints, and/or the like. Upon a positive validation, the system incorporates the modification into the shipment plan. However, if the system determines that the modification cannot be validated, meaning it does not conform to the information within the shipment ordering system, the system may provide a notification to the user of the inability to validate the modification. Once the shipment plan is finalized, the shipment ordering system tracks the transportation of the object in view of the shipment plan. Tracking of the transportation may vary based upon whether the modification could be validated or not.

Therefore, a system provides a technical improvement over traditional methods for the transportation of objects. The described shipment ordering system is able to determine whether a modification made to a shipment plan can be validated against information of the shipment ordering system. This provides a user with a notification regarding whether the change is possible or whether it will create an issue with the transportation of the object. Accordingly, the user can be apprised of any potential issues and try to avoid those issues. Additionally, even in the case of a modification, the shipment ordering system can still track the shipment to determine if any exceptions were made to the shipment plan. Additionally, the described system is more automated than the traditional techniques, which results in more accurate determinations of transport success than conventional systems. Thus, the described shipment ordering system is more efficient and accurate in the generation of shipment plans and addressing modifications to the shipment plans.

The illustrated example embodiments will be best understood by reference to the figures. The following description is intended only by way of example, and simply illustrates certain example embodiments.

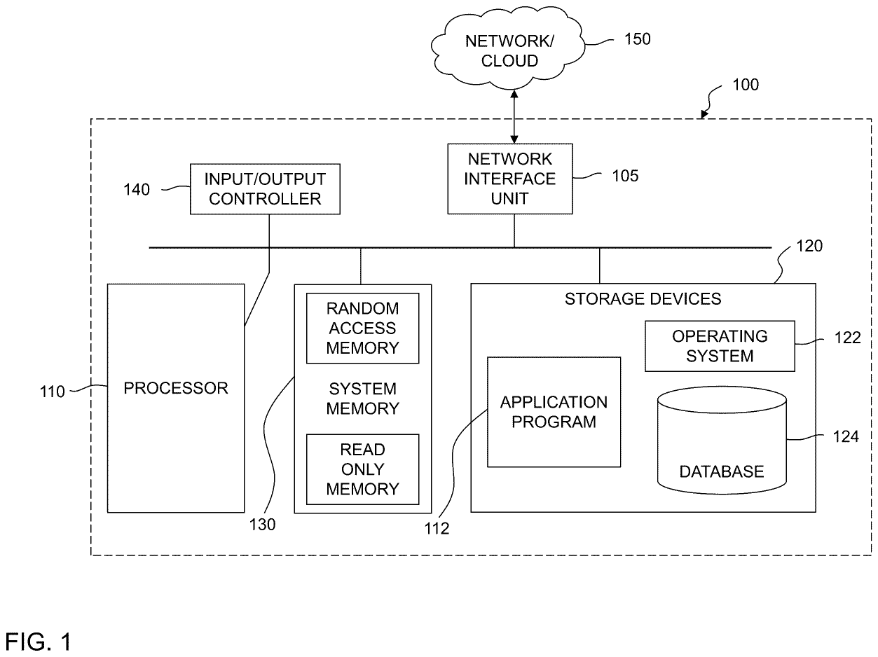

While various other circuits, circuitry or components may be utilized in the described system, an example is illustrated in FIG. 1. In the example of FIG. 1, storage devices 120 includes software such as a workflow graphical user interface application program 112 that may be run or executed by processor(s) 110 according to an operating system 122. The circuitry 100 provides that the processor 110 loads the operating system 122 and thereafter the application program 112, e.g., into memory 130.

System 100 typically includes a network interface 105 facilitating communications with other devices, e.g., a connection to other devices over a network 150 (which may include a local network, remote network, cloud network, etc.) using components such as a WWAN transceiver, a WLAN transceiver or a wired connection, e.g., a LAN connection. Commonly, system 100 will include an input/output controller 140 for data input and display. System 100 typically includes various memory 130 and storage devices 120, for example a database 124, e.g., for storing data from internal and external data sources, referred to herein.

Device circuitry, as for example outlined in FIG. 1, may be used to generate, manage, and process data collected during the operation of the program. It will also be apparent that circuitry other than the non-limiting example outlined in FIG. 1 may be used. Information handling device circuitry, as for example outlined in FIG. 1, may be used in devices such as tablets, smart phones, personal computer devices generally, electronic devices, and/or the like, that may interface with the shipment ordering system, be a part of the shipment ordering system, and/or utilized by users, including transporters, to access information provided within or by the shipment ordering system.

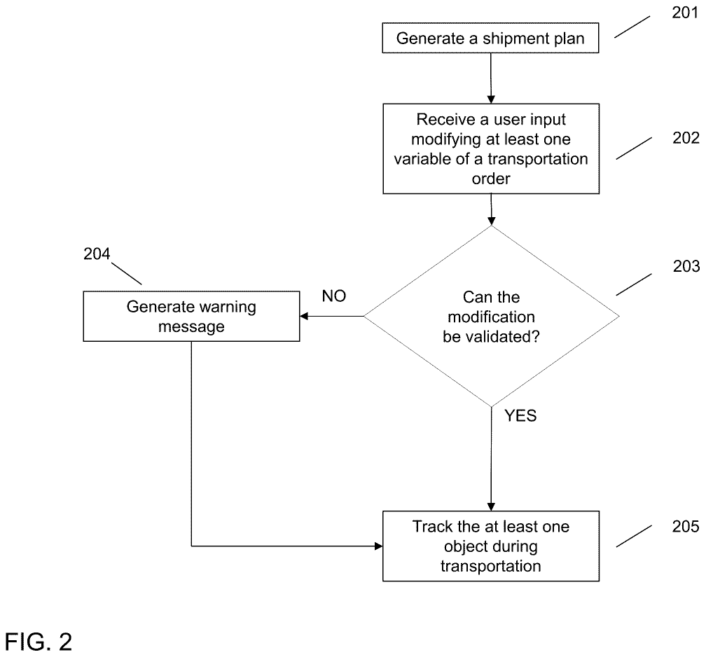

FIG. 2 illustrates an example method for receiving and validating modifications to a shipment plan for an object and tracking the object during the transportation. The method may be implemented on a system which includes a processor, memory device, output devices (e.g., display device, etc.), input devices (e.g., keyboard, touch screen, mouse, microphones, sensors, biometric scanners, etc.), image capture devices, and/or other components. While the system may include known hardware and software components and/or hardware and software components developed in the future, the system itself is specifically programmed to perform the functions as described herein to generate a shipment plan and address modifications to the shipment plan. Additionally, the shipment ordering system includes modules and features that are unique to the described system.

The shipment ordering system may be utilized to account for a modification made to a shipment plan, specifically, modifications to a shipment plan. In order to utilize the shipment organization system, the system may be activated, either as a standalone application, as a module that works with another application, and/or the like, or a combination thereof. The system may be automatically activated by an application that provides instructions to the system or may be manually activated by a user providing input to the system. The automatic activation of the shipment ordering system may be based upon the detection of a trigger event indicating that the system should be activated. Example trigger events include receipt of a user input modifying at least one variable of a shipment plan, receipt of a shipment at an information handling device, activation of software or an application utilizing the shipment ordering system, and/or the like.

The shipment ordering system may be made of multiple systems or modules that communicate together to make up the shipment ordering system or may be a single system. The shipment ordering system may be a system within an organization, for example, a logistics organization, a supplier, and/or any other organization that may arrange transport of objects. The shipment ordering system may communicate with other systems within the organization and may also communicate with other systems outside the organization, for example, systems of other entities that may transmit transportation requests, for example, organizations that want transportation objects transported, inventory control organizations, transportation request generation organizations, and/or the like. Thus, the shipment ordering system may include components or modules that allow for the communication between the shipment ordering system and the internal and/or external systems. These components or modules may be all located on a single computing device or single computing system, or different components or modules of the system could be located across multiple computing devices or multiple computing system.

The shipment ordering system may be a standalone system, may be accessible through other computing devices, and/or a combination thereof. For example, the shipment ordering system may be a standalone system that can be accessed by a user and/or may be or provide an application that is accessible by a user on another computing device. The shipment ordering system may be accessible using any type of computing device, for example, personal computer, laptop computer, smartphone, tablet, smartwatch, head-mounted display, smart television or other smart appliance, augmented reality device, virtual reality device, and/or the like. Thus, the shipment ordering system may be accessible locally using a computing device where the shipment ordering system is installed and/or may be accessible remotely through another computing device. For example, the shipment ordering system may be accessed by a user using a device that communicates with the shipment ordering system to provide instructions for generating shipment plans, receiving modifications to the shipment plan, and/or the like. However, the shipment ordering system may be located and operate on a different information handling device to perform the described steps. For example, the shipment ordering system may be located and operate on a cloud computing device, a computing device accessed through a remote network, a computing device accessed through a local network, and/or the like, or a combination thereof.

The shipment ordering system may have an associated graphical user interface. The graphical user interface may be provided on a display or monitor, which may or may not be associated with the shipment ordering system. In other words, the shipment ordering system may have a dedicated display or monitor or may be accessible using any display or monitor. In either case, the shipment ordering system may provide instructions to generate and display the graphical user interface on the display device being used to access the shipment ordering system. The graphical user interface may also be updated and managed based upon instructions provided by the shipment ordering system. In other words, the shipment ordering system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the shipment ordering system. For example, the shipment ordering system may utilize historical information, transporter information, origin location information, destination location information, inventory information, and/or the like, to process a transportation request, generate a shipment plan including transportation orders, validate modifications to shipment plans, and/or the like. The graphical user interface may allow for creation of or access to these profiles, historical information, and/or the like, by allowing a user to input information regarding the locations, schedules, information, and/or the like. As will be discussed in more detail, the use of user provided information is not the only way that the historical information, transporter information, location information, and/or the like, can be created. The shipment organization system can then utilize these inputs to store the historical information, identify shipment plan modifications, and/or the like.

A user could also use the graphical user interface to adjust information stored within the system, make changes to generated shipment plans, access information utilized to generate the shipment plan, and/or the like. Additionally, or alternatively, the user can input a location of information related to the information, provide a file corresponding to the information or portion thereof, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, and/or the like.

The graphical user interface may also provide displays that display different information that is utilized by the system, output by the system, generated by the system, and/or the like. It should be noted that the information to be used by the shipment ordering system and information provided by the shipment ordering system can be different for different applications, different computing systems, different users, and/or the like. Thus, the information corresponding to input or output of the shipment ordering system are not always the same. However, the shipment ordering system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The shipment ordering system may utilize one or more artificial intelligence models in generating the shipment plan, validating a modification to the shipment plan, tracking the transportation of an object, and/or any other steps included in the system or method. Artificial intelligence models may also be used for steps within a step. For example, a model could be utilized to validate the shipment plan when generating the shipment plan, analyzing sensor data in tracking the transportation of the object, and/or the like. For ease of readability, the majority of the description will refer to a single artificial intelligence model. However, it should be noted that an ensemble of artificial intelligence models or multiple artificial intelligence models may be utilized.

Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model that is fine-tuned for the shipment ordering system or may be a model that is created from scratch. Since the shipment ordering system is used in conjunction with validating modifications to shipment plans and tracking the transportation of the object in view of the shipment plan, some models that may be utilized by the system are text analysis models, image analysis models, sensor information analysis models, other analysis models, optimization models, similarity identification models, large language models, language models, filtering models, classification models, mapping models, and/or the like. The model may be trained using one or more training datasets. Additionally, as the model is deployed, it may receive feedback to become more accurate over time. The feedback may be automatically ingested by the model as it is deployed. For example, as the model is used to perform the described method, if a user modifies information that was generated by the model, provides feedback regarding a prediction, or otherwise provides some indication that the predictions or modifications made by the model may be incorrect, the model ingests this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like. The ingesting of feedback may be automatic or manual and may be dependent upon the type of feedback and the deployment mode (e.g., training, deployed, testing, etc.) of the artificial intelligence model.

As previously mentioned, an ensemble of models or multiple models may also be utilized. Some example models that may be utilized are variational autoencoders, generative adversarial networks, recurrent neural network, convolutional neural network, deep neural network, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model.

The shipment ordering system may include different components for carrying out different functions of the system, including different steps to be performed. These components may be hardware components or software components. Some hardware devices or components that may be utilized by the shipment ordering system include input devices that may be utilized to receive input from the user, for example, mechanical input modalities (e.g., keyboard, mouse, etc.), touch input devices, gesture input devices, electromyography input devices, audio input devices, biometric input devices, and/or the like. Other hardware components may be utilized to provide output from the shipment ordering system. For example, the shipment ordering system may include speakers, displays or monitors, haptic output devices, audio output devices, and/or the like. Other hardware components may include data storage devices, including on devices of the user (e.g., mobile device, personal computer, laptop, tablet, smart watch, etc.), devices or components of the shipment ordering system, and/or the like.

One software component that may be utilized are profiles. These profiles may be associated with particular transportation customers or entities whose products or goods are being transported, origin locations, destination locations, particular transporters, and/or the like. The profiles may include preferences of an entity associated with the profile, requirements or restrictions of an entity associated with the profile, schedules of an entity associated with the profile, regulations that may be associated with an entity, information related to inventories of transportation objects, and/or the like. For example, a transportation customer profile may identify preferences of the customers who are requesting a particular transportation object. These preferences might include, but are not limited to, a preferred delivery schedule, preferred transporters, destination locations, a preferred frequency of delivery, any restrictions (e.g., restrictions regarding other objects that can be co-located on transportation vehicle with the object, regulations applicable to particular objects, how quickly objects need to be delivered, etc.), and/or the like.

For example, a profile associated with an origin location may identify hours of operation, hours that goods or transportation objects can be picked up (e.g., only during business hours, only after hours, a subset of business hours, a range of hours, certain days, etc.), types and sizes of trucks or transportation vehicles that can access the origin location, equipment available for use at the origin location (e.g., forklift, hand carts, loading dock types, pallets, cranes, etc.) and a schedule of the equipment availability, employees that can release transportation objects and a schedule of these employees, preferences of the origin location (e.g., preferred transporters, preferred pick up schedules, preferred frequency of order pick up, etc.), inventory delivery schedules, and/or the like. A profile associated with a destination location may have similar information as the profile associated with an origin location.

An inventory profile may be associated with different transportation objects and/or orders. In other words, each transportation object present within an transportation order may have an inventory profile. Additionally, or alternatively, an inventory profile may include information for multiple different transportation objects. Transportation objects may also be grouped into different groups with each group having an associated inventory profile. Groupings can be made using many different techniques, for example, groupings could be based upon transportation object categories (e.g., household goods, clothing, automotive objects, office products, electronic devices, furniture, user devices, food products, petroleum products, liquid products, gas products, etc.), groupings could be based upon customers (e.g., objects delivered to a single customer are grouped, objects delivered to customers within a particular region or area are grouped, etc.), groupings could be based upon a frequency of deliveries, and/or any other grouping that may be useful.

The inventory profile may include, but is not limited to, information related to transportation objects that are useful for determining a transportation schedule that is then presented as a transportation order. Thus, the inventory profile may identify locations where inventory of the transportation objects is located (e.g., a warehouse, a manufacturing facility, etc.), identify how much of the transportation object is located at each location, identify when a transportation object will expire (if applicable), identify when a transportation object was placed at a particular location, identify how frequently the transportation object is replenished at a location, and/or the like. Thus, the inventory profile may contain any information that can be utilized to optimize from which origin location the object should be picked up, as is described in the transportation order.

The transporter profile may include a schedule of the transporter, regulations applicable to a transporter (e.g., a maximum number of working hours for a predetermined time frame, a required number of rest hours, route restrictions, etc.), whether the transporter works on a team, preferences of the transporter (e.g., preferred origin or delivery locations or regions, preferred load types (e.g., van loads, flatbed loads, tarped loads, less-than-a-load loads, multiple stop loads, etc.), preferred delivery routes, preferred delivery durations, etc.) transportation vehicle specifications, current routes of a transporter, current locations of a transporter, and/or the like. Thus, the transporter profile may include any information that can assist in creating a schedule and route for a particular transportation request.

It should be noted that information stored within a profile can change and may even change in real-time. For example, since a transporter profile may identify information related to when a transporter is available, this information may change as the transporter works, rests, takes vacation, and/or the like. In other words, the schedule of the transporter may be updated as new information is received, which may be in real-time or at particular frequencies. As another example, an inventory profile may change as inventory of a transportation object changes, for example, as inventory is added to a location or removed from a location.

Additionally, it should be noted that the types of information that are stored within the system or accessible to the system is not strictly limited to the types of information that have been discussed as it can be readily understood that other information may be useful and utilized. Thus, the described information is only for illustrative purposes and is not intended to be limiting to only that information described.

Another software component that may be utilized by the system is a database or other data storage location where the system can store information, including historical information, the profile information, current information, and/or the like. The information stored within the data storage location may be stored within a single data lake or data storage location or may be separate data lakes or data storage locations that may be divided by customers, transporters, transportation requests, transportation objects, and/or the like. For example, each customer may have their own data storage location and any historical information related to the customer will be stored within the data storage location of the customer. The historical information can be utilized by the system to determine a schedule for transporting transportation objects. This information contained and/or accessible by the shipment ordering system may be referred to as master data and can be utilized in generating shipment plans and validating modifications to shipment plans.

At 201, the shipment ordering system may generate a shipment plan. A shipment plan may be based upon a transportation request. The transportation request may be transmitted by another system, for example, another system internal to the organization employing the shipment ordering system, another system that is external to the organization employing the shipment ordering system, and/or the like. For example, a company may want to have transportation objects transported to a destination location. This company may then transmit a transportation request to a logistics organization that coordinates the transportation of the transportation object. A transportation object can be any type of product or object that can be transported from one location to another utilizing a transportation vehicle. Thus, transportation objects may include, but are not limited to, furniture, people, petroleum products, gas products, liquid products, food objects, office products, paper products, clothing, household objects, electronics, medical objects, and/or the like. For ease of readability, a transportation object may also be referred to as an object or product. However, these terms are not intended to limit the transportation object in any way.

The transportation request may identify a transportation object, an amount of the transportation object that needs to be transported, and a destination location for the transportation object. The transportation request may also identify to where the transportation object is to be delivered, which is referred to as the destination location. It should be noted that it is possible to have multiple destination locations for either portions of the same transportation object or for different objects that are on the same transportation vehicle. Multiple destinations for the same transportation vehicles are generally referred to as multi-stop routes. Loads that take up less than the entirety of a transportation vehicle are generally referred to as less-than-a-load (LTL) loads. With these loads, logistic companies often try to add multiple LTL loads together to make a full load for the transportation vehicle. Such LTL loads may require the transportation vehicle to access multiple origin locations, meaning the vehicle may pick up different LTL loads at different origin locations. Alternatively, in the case of the origin location being a warehouse that houses objects from many different suppliers and for many different customers, the vehicle may be able to pick up different LTL loads all at the same origin location.

The transportation request may also include additional information, for example, an origin location, a requested delivery time and/or date, a schedule for the transportation request, a customer associated with the transportation request, an applicable supplier, any requests associated with the transportation request, restrictions associated with the transportation object (e.g., a stacking height, loading type restrictions (e.g., fork lift loading, hand loading, etc.), restrictions against loading with other objects (e.g., cannot be loaded with other food items to maintain Kosher requirements, cannot be loaded with combustible materials, can only be loaded with other products of the same type, cannot be loaded with other loads, etc.), load size restrictions, etc.), load cover requirements (e.g., van or box, tarped, open, chained, etc.), a preferred transportation vehicle type, and/or the like.

From the transportation request, the shipment ordering system can generate a transportation order for the object(s) of the transportation request. The transportation order(s) can then be used to generate a shipment plan. The shipment plan identifies the details regarding how the objects will be transported from an origin location to a destination location. The transportation orders may include the details for the transportation of objects for a part of the shipment plan. For example, a transportation vehicle that will be transporting multiple object types may have transportation orders for each of the object types that are being transported. The combination of these transportation orders makes up the shipment plan. Transportation orders may be generated for different characteristics, for example, transportation orders may be based upon an object type, may be based upon destinations (e.g., an object would have a transportation order for the transport from location A to location B and another transportation order for the transport from location B to location C, etc.), may be based upon certain time frames (e.g., an object would have a transportation order that encompasses a first 10-hour time frame and another transportation order for a second 10-hour time frame, etc.), may be based upon the transporter or transportation vehicle of different portions, and/or the like.

From the transportation orders, the system can generate a shipment plan which is an aggregation of the transportation orders. In generating the transportation orders and/or shipment plan, the system validates the variables of the transportation. As discussed further herein, the variables can include a number of items or objects within the shipment, identifiers of objects (e.g., object names, object types, object stock keeping units (SKU), etc.), origin location, destination location, transportation vehicle, transportation vehicle type, transportation vehicle identifier (e.g., license plate number, federal identification number, transporter identification number, transportation company, etc.), transporter and/or transporter identifier, receiver identifier, time of departures, time of arrivals, number of drops within the shipment, and/or the like. Thus, the variables can be any information that may be included in a transportation request, transportation order, shipment plan, and/or master data within the shipment ordering system. This validation includes ensuring that the variables are correct in view of any transportation constraints, inventory constraints, or any other information included in the master data. Thus, the system may compare the variables against the any transportation constraints, inventory constraints, or other master data information.

The transportation of goods is subject to transportation constraints, which are factors or variables that restrict or influence some portion of the transportation of the goods. Transportation constraints may include, but are not limited to, transporter regulatory requirements (e.g., routes that transportation vehicles are allowed to take, routes that certain objects are allowed upon, how many hours a transporter can work in a predetermined time period, how many hours a transporter has to rest within a predetermined time period, etc.), current locations of transporters, schedules of transporters (e.g., vacation schedule, working hour schedules, preferred route lengths, a time since last home stay, etc.), destination location constraints (e.g., transportation vehicle constraints, hours that objects can be delivered at the destination location, certain people who have to be present for deliveries, loading dock constraints, whether transportation vehicles can enter the destination location after hours and park, whether transportation vehicles can leave the destination location after hours, any certification requirements, loading/unloading assistance availability and tools, etc.), and/or the like.

Inventory constraints are factors or variables that restrict or influence some portion of the storage or delivery of the goods. Inventory constraints may include, but are not limited to, origin location constraints (e.g., hours of operation, hours allowed for pick up, allowed transportation vehicle types, loading/unloading assistance and tools, etc.), an inventory amount of the object within a particular origin location, a length of time the transportation object has been within an origin location, a location of an origin location with respect to a transporter, transportation object transportation requirements (e.g., whether the object can be loaded with other objects and what types of objects, whether the object needs a particular transportation vehicle type, whether the object has loading or transport requirements, whether the object has to be verified or locked on the transportation vehicle, etc.), and/or the like. Thus, the transportation orders and, therefore, the shipment plan, are generated so as to meet or fulfill any transportation constraints, inventory constraints, or other information contained within the master data. This means that the transportation orders and shipment plan have been validated against the master data.

Additional information related to the transportation request, the generation of transportation orders, and the generation of shipment plans, can be found in commonly owned application having Ser. No. 18/947,887, entitled “Transportation Optimization”, and filed on Nov. 14, 2024, the contents of which are incorporated by reference herein as if they were fully set forth herein.

At 202, the shipment ordering system may receive a user input modifying at least one variable of a shipment plan. In other words, the shipment order system receives a user input that includes a modification of the shipment plan, which may include a modification of a transportation order included in the shipment plan. Modifications to the shipment plan may be made for any number of reasons including, but not limited to, due to an unforeseen issue with the shipment plan, due to a change in information for the transporting company, simply because a user wants to, due to a request for object transportation received after the generation of the shipment plan, and/or the like. In providing the modification, a user may modify at least one variable of the shipment plan. Modifying at least one variable may be object specific and/or across an entire shipment plan. In other words, a modification to a transportation variable may influence a single object, for example, increasing an amount of an object present within transportation request, changing a destination location of an object, changing a destination location of an object, and/or the like. Additionally, and/or alternatively, a modification to a transportation variable may influence all transportation orders present within the shipment plan, for example, assigning a new transportation vehicle for all objects, changing a transporter, adding a stop in the shipment plan, and/or the like.

The shipment ordering system may accept a user input including a modification utilizing traditional system input methods. The shipment ordering system may include a graphical user interface that may display the shipment plan. The user can then provide input to the shipment plan displayed on the graphical user interface to provide the modification. For example, the user could select one of the transportation variables within the shipment plan and then provide the modification to the shipment plan. For example, subsequent to a user determining that a modification to an amount of an object is desired, a user may select a “quantity” variable for an object and provide an input at the shipment ordering system to make the modification. The input may include, but is not limited to, a typing input, a touch input, and/or the like.

Other techniques for providing a modification are possible and contemplated. For example, a user could make a modification to a paper form of the shipment plan and then scan or otherwise take an image of the modified paper to provide to the system. The system could then analyze the document to identify the modification and then make a corresponding modification within the shipment plan contained or accessible to the system. As another example, sensors associated with and/or coupled to an information handling device employing a shipment ordering system may be utilized to assist with detecting or receiving user inputs at the information handling device. For example, an information handling device that includes an audio capture device may receive audible input while the shipment ordering system is active. The system can then parse and analyze this input to perform a modification to at least one transportation variable. Thus, the modifications can be provided using any type of user input and may be provided in any format including, but not limited to, input within a graphical user interface, by providing or updating files, using a command line, using audio, gesture, and/or the like, input, and/or the like.

Upon receiving the modification, the shipment order system may determine if the modification to the transportation order can be validated at 203. The validation of the modification can be performed automatically without any user input regarding the validation. The system can validate the modification against the master data without requiring user input. The validation may be performed using an artificial intelligence model as discussed further herein. Additionally, the validation may or may not be checked by a person after the validation has been performed. Additionally, the validation may occur when the modification is received, meaning the validation may be performed in real-time. Thus, the validation can occur very quickly after receiving the modification so that the shipment is not delayed to perform the validation.

Validating the modification may include performing a similar validation as was performed when generating the transportation order and/or shipment plan. Thus, the validating may include validating the modification against the information of the shipment ordering system. In validating the modification, the shipment ordering system is attempting to determine if the modification fulfills the requirements of the master data. In other words, based upon the master data, the system is trying to determine if the modification is possible or an acceptable modification. The system may validate the modification against the transportation constraints, inventory constraints, or other information within the master data. Validating the modification may also mean determining whether the modification conforms with the information of the shipment ordering system. Thus, the system may identify the information of the modification and determine if that information will fulfill the transportation constraints, inventory constraints, and/or other master data.

As an example, if the modification is changing a size of the transportation vehicle, the system may validate the modification by verifying whether the origin location will allow the new size of the transportation vehicle, verifying whether the new size of transportation vehicle is allowed on the designated route, verifying whether the destination location or any other locations will allow the new size of the transportation vehicle, and/or the like. Thus, in this example, the validation of the modification is to compare the new size of the transportation vehicle against the transportation constraints to determine if there is any conflict between the new size of the transportation vehicle and the transportation route. The validation of the modification includes validating all the variables that are affected by the modification. Thus, this simplistic example is provided for ease of readability and is not intended to be limiting, as validating a modification may include validating many more variables as identified in this example,

Validating the modification may include using one or more artificial intelligence models. The model(s) may be trained using historical information related to the transportation of objects. The historical information may identify the shipment plans for objects that have been previously been transported. The historical information may also include any information related to whether the shipment plan was followed or whether any modification or exceptions were made to the shipment plan. While a modification is an intended change, an exception may be a change to the shipment plan that is caused by something other than a user input, for example, a road construction, a change in a transportation constraint after the transportation has been started, a change in an inventory constraint after the transportation has been started, and/o the like. The models may also be trained using the master data.

In validating the modification, the system determines whether the master data indicates an issue with the modification or not. A negative validation includes identifying that the modification is not acceptable (no at 203). An unacceptable modification to at least one variable of the shipment plan is a modification that creates a conflict with the master data. For example, if the size of the transportation vehicle is increased and the system determines that the destination location cannot support the larger transportation vehicle based upon the master data, the system will generate a negative validation. When it is determined that the modification is unacceptable, the shipment ordering system may generate a notification or warning message at 204. In other words, if the shipment ordering system determines during the validation that there is an issue with the modification, the system may provide a notification to the user indicating the issues.

The notification or warning may state that the modification will result in the shipment plan conflicting with the shipment plan. In other words, a warning message produced by the shipment ordering system may inform a user that the modification of a variable will severely influence the transportation of the object in view of the shipment plan. Generating a warning message may include a notification that the modification cannot be performed. The notification may also indicate the issue with the modification. For example, the notification may indicate what portion of the master data conflicts with the modification. Using the example above, the notification may include identifying that the destination location cannot accept the larger transportation vehicle. The notification may also provide some options for addressing the conflict. For example, the notification can allow the user to ignore the notification and continue with the modification, the notification may identify some options that would not conflict with the master data but that may be different than the original shipment plan, the notification could allow the user to delete the modification and revert to the original shipment plan, and/or the like. While a message or visual notification has been discussed, it should be noted that the notification or warning may also, or alternatively, be provided in a different output modality, for example, an audible output, a haptic output, and/or the like.

In addition to, or alternatively, providing a notification, the system may also take other actions if the system produces a negative validation. For example, the system could cancel or terminate the shipment plan if the modification creates an infeasible shipment plan. This may result in the modified shipment plan being rejected. The user could then revise the modified shipment plan, which would result in this new modified shipment plan being validated. Alternatively, the user could cancel the entire shipment, cancel a portion of the shipment plan, and/or the like. As another alternative, the user could override the rejection of the modified shipment plan.

On the other hand, if the modification can be validated, the system may provide a positive validation. A positive validation includes identifying that the modification is acceptable (yes at 203). An acceptable modification to at least one variable of the shipment plan is a modification that still meets the master data. Like with the negative validation, a positive validation may also include providing a notification to the user indicating that the modification has been validated. On the other hand, a positive validation can simply result in the change to the shipment plan with no notification to the user regarding the positive validation. Since a positive validation means that there is no conflict with the master data, the system may incorporate the modification and generate a new shipment plan that includes the modification. This information can also be utilized by the system to further train the artificial intelligence model, if applicable.

Regardless of whether the validation results in a positive or negative validation, the system may track the transportation of the object in view of the shipment plan at 205. Tracking the transportation of the object may include utilizing sensors, devices, and/or the like, that can track objects, transporters, transportation vehicles, and/or the like. In the case of a negative validation, the system may or may not track the modification. Whether the modification is tracked or not may be determined by the transporting entity, may be determined by the logistics company, may be set in response to the negative validation, may be based upon the modification, and/or the like. Tracking the modification includes tracking the object during the entire transportation, even during the portion of the transportation that does not conform to the shipment plan. Thus, the details related to the modification and captured during effectuation of the modification of the transportation will be tracked and provided to the shipment ordering system.

Not tracking the object during the modification includes not tracking the object during the portion of the transportation that is related to the modification. Alternatively, the object may be tracked, but those tracking details may be excluded or not transmitted to the shipment ordering system. Thus, the details related to the modification and, if applicable, captured during effectuation of the modification of the transportation will not be tracked and/or provided to the shipment ordering system. The tracking details, regardless of whether they include the modification tracking details, may be stored in the data repository to be utilized by the shipment ordering system for the generation of subsequent shipment plans.

Upon tracking the transportation of the object, the shipment ordering system may generate a shipment report based upon the tracking. The shipment report is a report that is generated after an object has been transported and includes information related to the transportation of the objects, for example, when the objects were delivered, how long the transportation took, a name of the transporter, a transportation vehicle the performed the transportation, and/or the like. The shipment report may also identify if any exceptions occurred to the shipment plan (e.g., the expected delivery time was not met, an identified transportation constraint was changed resulting in an issue, etc.). The shipment report may also identify if a modification that was made to the shipment plan had an expected result. In other words, the system may determine if the modification that was either positively or negatively validated had the expected positive or negative result. Thus, for a positive validation, the system may determine if the validated modification resulted in an exception. Similarly, for a negative validation, the system may determine if the modification actually resulted in problems or issues with the transportation of the object. In other words, the shipment report can verify the validation (either positive or negative) of the modification.

The shipment report can then be presented to the transporting entity, logistics company, and/or the like. The shipment report can also be provided to the shipment ordering system and the information can be stored in the data repository. This information can then be used to influence subsequent shipment plan generation.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated. Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, the method comprising:
generating, utilizing a shipment ordering system, a shipment plan, wherein the shipment plan comprises at least one transportation order for at least one object, wherein the shipment plan comprises a plurality of variables, each of the variables corresponding to a piece of information included within the shipment plan;
receiving, at the shipment ordering system, user input comprising a modification for modifying at least one variable of the plurality of variables of the shipment plan;
automatically validating, using the shipment ordering system, the modification to the shipment plan against master data contained within a data storage location accessible to the shipment ordering system, wherein the master data comprises information related to the plurality of variables, wherein the automatically validating comprises validating at least a subset of the plurality of variables, wherein the at least a subset comprises the variables affected by the modification; and
tracking, utilizing the shipment ordering system, transportation of the at least one object in view of the shipment plan.

2. The method of claim 1, further comprising generating a shipment report based upon the tracking.

3. The method of claim 1, wherein the generating the shipment plan comprises generating the shipment plan based upon transportation constraints.

4. The method of claim 1, wherein the validating comprises comparing the modification against transportation constraints related to the modification.

5. The method of claim 1, wherein the validating comprises determining whether the modification conforms with the information of the shipment ordering system.

6. The method of claim 1, wherein the validating comprises identifying an issue with the modification and providing a notification to a user indicating the issue.

7. The method of claim 1, wherein the tracking comprises excluding tracking details related to the modification to the shipment plan.

8. The method of claim 1, wherein the tracking comprises tracking details related to the modification to the shipment plan.

9. The method of claim 1, wherein the validating comprises utilizing an artificial intelligence model trained using historical information related to transportation of objects.

10. The method of claim 1, wherein details corresponding to the tracking are stored in a data repository of the shipment ordering system and utilized by the shipment ordering system for generation of subsequent shipment plans.

11. A system, the system comprising:
a processor;
a memory device that stores instructions that, when executed by the processor, causes the system to:
generate, utilizing a shipment ordering system, a shipment plan, wherein the shipment plan comprises at least one transportation order for at least one object, wherein the shipment plan comprises a plurality of variables, each of the variables corresponding to a piece of information included within the shipment plan;
receive, at the shipment ordering system, user input comprising a modification for modifying at least one variable of the plurality of variables of the shipment plan;
automatically validate, using the shipment ordering system, the modification to the shipment plan against master data contained within a data storage location accessible to the shipment ordering system, wherein the master data comprises information related to the plurality of variables, wherein the automatically validating comprises validating at least a subset of the plurality of variables, wherein the at least a subset comprises the variables affected by the modification; and
track, utilizing the shipment ordering system, transportation of the at least one object in view of the shipment plan.

12. The system of claim 11, further comprising generating a shipment report based upon the tracking.

13. The system of claim 11, wherein the generating the shipment plan comprises generating the shipment plan based upon transportation constraints.

14. The system of claim 11, wherein the validating comprises comparing the modification against transportation constraints related to the modification.

15. The system of claim 11, wherein the validating comprises determining whether the modification conforms with the information of the shipment ordering system.

16. The system of claim 11, wherein the validating comprises identifying an issue with the modification and providing a notification to a user indicating the issue.

17. The system of claim 11, wherein the tracking comprises excluding tracking details related to the modification to the shipment plan.

18. The system of claim 11, wherein the tracking comprises tracking details related to the modification to the shipment plan.

19. The system of claim 11, wherein the validating comprises utilizing an artificial intelligence model trained using historical information related to transportation of objects.

20. A product, the product comprising:
a computer-readable storage device that stores executable code that, when executed by a processor, causes the product to:
generate, utilizing a shipment ordering system, a shipment plan, wherein the shipment plan comprises at least one transportation order for at least one object, wherein the shipment plan comprises a plurality of variables, each of the variables corresponding to a piece of information included within the shipment plan;
receive, at the shipment ordering system, user input comprising a modification for modifying at least one variable of the plurality of variables of the shipment plan;
automatically validate, using the shipment ordering system, the modification to the shipment plan against master data contained within a data storage location accessible to the shipment ordering system, wherein the master data comprises information related to the plurality of variables, wherein the automatically validating comprises validating at least a subset of the plurality of variables, wherein the at least a subset comprises the variables affected by the modification; and
track, utilizing the shipment ordering system, transportation of the at least one object in view of the shipment plan.
